(19) United States
(12) Patent Application Publication
(10) Pub. No.: US 2026/0082473 A1
(43) Pub. Date: Mar. 19, 2026

(54) ELECTRONIC CIRCUIT AND METHOD OF HEATING A FILAMENT OF AN X-RAY TUBE

(71) Applicant: Siemens Healthineers AG, Forchheim (DE)

(72) Inventors: Wei FAN, Erlangen (DE); Thomas WEIDINGER, Erlangen (DE); Leopold OTT, Ahorn (DE); Josef DEURINGER, Herzogenaurach (DE)

(73) Assignee: Siemens Healthineers AG, Forchheim (DE)

(21) Appl. No.: 19/332,128

(22) Filed: Sep. 18, 2025

(30) Foreign Application Priority Data
Sep. 19, 2024 (EP) 24201355.5

(51) Int. Cl. H05G 1/30; H05G 1/26

(52) U.S. Cl. CPC H05G 1/30; H05G 1/265

(57) ABSTRACT

An electronic circuit is configured to provide an AC heating voltage for heating a filament of an X-ray tube. The electronic circuit contains an inverter configured on the input side to receive a DC heating voltage and to convert the DC heating voltage depending on a manipulated variable into an AC heating voltage and to make available the AC heating voltage on the output side. Similarly, the electronic circuit contains a controller configured to measure the AC heating voltage and an AC heating current resulting from the AC heating voltage and depending on the AC heating voltage and the AC heating current to determine a controlled variable. The controller is configured to vary the manipulated variable depending on the controlled variable, in order to regulate the controlled variable in a regulating circuit to a specified target value.

### CROSS-REFERENCE TO RELATED APPLICATION(S)

The present application claims priority under 35 U.S.C. § 119 to European Patent Application No. 24201355.5, filed Sep. 19, 2024, the entire contents of which are incorporated herein by reference.

### FIELD

One or more example embodiments relates to an electronic circuit for providing an AC heating voltage for heating a filament of an X-ray tube. One or more example embodiments also relates to an X-ray tube system with such an electronic circuit and a medical imaging system with such an X-ray tube system. One or more example embodiments furthermore relates to a corresponding method for providing an AC heating voltage and for heating a filament of an X-ray tube.

### RELATED ART

An X-ray tube is a special cathode ray tube for generating X-rays. X-ray tubes are used in various imaging methods and offer a number of options, including in modern medicine.

For generating X-rays via an X-ray tube, free electrons are required which with the help of a defined tube high voltage may be accelerated from a cathode to an anode. The electrons released, and hence the charges, which flow per unit of time from the cathode to the anode, are referred to as tube current. For generating the free electrons, the cathode is designed as a filament, for example in the form of a tungsten emitter. The filament is heated by an electrical current flow to such an extent that electrons are released from the metal lattice of the filament. The current flow through the filament is referred to in the following as filament current.

An X-ray dose is generated depending on the tube high voltage and the tube current. The tube current is related to the filament current. Hence the filament current must be set in such a way that the desired temperature of the filament is reached and thus the right tube current is generated.

Since in many cases the cathode is at a high voltage potential resulting from the tube high voltage, in such cases galvanic isolation in the form of a transformer, also known as a filament transformer, is necessary for insulation purposes. The consequence of this is that the filament current may only be directly detected with the help of complicated and costly evaluation electronics at high voltage potential. The evaluation electronics may have to exchange data with the control electronics for the semiconductor switches on the primary side. Instead of this, in the prior art the primary-side current of the transformer, referred to as the AC heating current, is measured and used as a controlled variable.

Since the emission curve of the X-ray tube, which represents the ratio between the tube and AC heating current, may have a very steep gradient, when regulating the AC heating current a highly accurate detection of the AC heating current is needed, which is similarly associated with highly complicated and costly circuitry.

Since certain tolerances in the detection of the AC heating current and temperature dependencies in a heating output channel nevertheless remain, and an emission characteristic of an X-ray tube is also subject to a certain tolerance, an actual ratio between tube and AC heating current must be calibrated using test scans, in order to meet the tube current requirements. This procedure is referred to as filament learning. Due to the aging of the emitter resistor or the filament resistor and the associated change in its resistance value, the filament learning must be repeated at defined intervals to continue to ensure sufficient accuracy. The approach outlined is described in detail in the technical literature, e.g. in [Behling, 2021: Modern Diagnostic X-Ray Sources: Technology, Manufacturing, Reliability].

### SUMMARY

One or more example embodiments regulates the tube current more accurately and/or quickly to the predefined target value.

This is achieved by the respective subject matter of the independent claims. Advantageous developments and preferred embodiments are the subject matter of the dependent claims, the following description and the figures.

### BRIEF DESCRIPTION OF THE DRAWINGS

In the following the invention is described in more detail based on specific exemplary embodiments and associated schematic drawings. In the figures identical or functionally identical elements may be provided with the same reference signs. The description of identical or functionally identical elements may not necessarily be repeated in the various figures.

In this way

FIG. 1 shows a schematic block diagram of an exemplary embodiment of an electronic circuit according to the invention; and

FIG. 2 a schematic block diagram of a further exemplary embodiment of the electronic circuit according to the invention; and

FIG. 3 a schematic block diagram of a further exemplary embodiment of the electronic circuit according to the invention; and

FIG. 4 a schematic block diagram of a further exemplary embodiment of the electronic circuit according to the invention.

### DETAILED DESCRIPTION

At least some example embodiments are based on the idea of regulating the heating of the filament with the aid of a controlled variable that depends on the AC heating current and the AC heating voltage on the output side of an inverter unit.

According to one or more example embodiments, an electronic circuit for providing an AC heating voltage for heating a filament of an X-ray tube is specified. The electronic circuit contains an inverter unit configured on the input side to receive a DC heating voltage and to convert the DC heating voltage depending on a manipulated variable into an AC heating voltage and to make available the AC heating voltage on the output side. The electronic circuit also contains a control arrangement configured to measure the AC heating voltage and an AC heating current resulting from the AC heating voltage and depending on the AC heating voltage, in particular the measured AC heating voltage, and the AC heating current, in particular the measured AC heating current, to determine a controlled variable. The control arrangement is configured to vary the manipulated variable depending on a controlled variable, in order to regulate the controlled variable in a regulating circuit to a specified target value.

In other words, the electronic circuit at the output of the inverter unit may make available a regulable AC heating voltage generated from the DC heating voltage, that may be used to heat the filament. The AC heating voltage may for example be galvanically isolated from the filament and for example passed through a transformer. This corresponds to an indirect provision of the AC heating voltage to the filament. The AC heating voltage may then be connected to the transformer on the primary side. The transformer may make available a filament voltage on the secondary side, which is connected to the filament. In this way the filament voltage depends in particular on the AC heating voltage. The filament voltage may produce a filament current, that heats the filament. The transformer may be configured so that the filament voltage has a larger voltage amplitude than the AC heating voltage, in particular the filament voltage may be referred to as filament high voltage.

In other embodiments the AC heating voltage may be directly connected to the filament. In this case, the AC heating voltage may also be referred to as filament voltage. This may be an alternative, for example, in cases where galvanic isolation is unnecessary. Galvanic isolation is in particular unnecessary if a voltage level of a tube high voltage at the filament corresponds to the ground level or is close to the ground level.

The inverter unit may in particular contain an inverter able to receive a DC heating voltage on the input side and convert the DC heating voltage depending on a manipulated variable into the AC heating voltage and make available the AC heating voltage on the output side.

The inverter may generate a variable output voltage. In this case the output voltage is the AC heating voltage. The manipulated variable may similarly be referred to as inverter operating parameter. Hence the inverter may generate the AC heating voltage, which may vary according to the value of the operating parameter. In particular, the control factor of the inverter may be varied via the manipulated variable. The inverter may in particular have a full-bridge or two half-bridges, which for example may be controlled by a PWM signal.

The control arrangement contains, for example, a measuring device configured to measure both the AC heating voltage and the AC heating current on the output side of the inverter, and hence for example contains a voltage measuring device and a current measuring device. In this way both values may be measured independently of one another. In particular, it may be necessary to calculate an RMS value from each of the two values, hence a RMS AC heating voltage and a RMS AC heating current, or to design the measurement in such a way that the RMS values may be directly determined.

Similarly, the control arrangement for example contains a controller configured to calculate the controlled variable and based on the controlled variable to output the manipulated variable. The controlled variable may comprise the measured values of the AC heating voltage and the AC heating current or be calculated on the basis of these, and hence dependent upon only the AC heating voltage and the AC heating current or dependent also on other variables. The calculation of the controlled variable may in particular include a division of the AC heating voltage by the AC heating current or vice versa.

The manipulated variable may be made available on the output side of the control arrangement and is connected to the inverter. For the controlled variable a target value may be specified, to which the controller aligns its regulation. In particular, the controller may generate a difference between the controlled variable and the target value and regulate this to a target value of the difference equal to zero. It is also possible for the target value to vary during the regulation process, and hence for the target value to be adjusted.

A change in the manipulated variable may bring about a change in the AC heating voltage, since the control factor of the inverter may vary. As soon as a filament is directly or indirectly connected to the electronic circuit, a change in the AC heating voltage may bring about a change in the AC heating current or the filament current and thus change the temperature of the filament. In turn, the temperature of the filament may influence a tube current and thus change an X-ray dose and is consequently a factor impacting the quality of an X-ray image.

An advantage of at least some example embodiments is the direct measurement of the relevant parameters for the regulation in the immediate environment of the filament. In particular, little or even no further knowledge of circuit components is necessary to draw conclusions about the filament temperature, since the values for the AC heating voltage and the AC heating current are immediately available.

Moreover, the gradient of the relationship between an AC heating current and the tube current is relatively steep, i.e. just a small change in the AC heating current has a major impact on the tube current. Conventional regulation, which is confined solely to the AC heating current as the controlled variable, may therefore regulate only very slowly and contain a large number of overshoots. The gradient is considerably flatter if a controlled variable is used that comprises the AC heating current and AC heating voltage components. This is the case with the electrical circuit according to at least some example embodiments, whereby inter alia the abovementioned object is achieved.

Finally, in this way the recording time and thus the applied X-ray dose of an X-ray image may be reduced.

A further advantage is that the filament learning process only has to be carried out after considerably longer intervals of time. The reason for this is that the regulation via a controlled variable comprising AC heating current and AC heating voltage directly reflects the defined discharge of electrons at the filament and thus significantly less levelling off of the emission power occurs as the filament ages. An essential feature of the filament, for example in the form of an impedance of the filament, may be estimated based on the measurement of the AC heating voltage and the AC heating current and thus does not require complicated teaching. In particular, estimating the impedance of the filament enables predictive maintenance of the X-ray tube.

According to at least one embodiment of the electronic circuit, the inverter unit contains an inverter configured, depending on the DC heating voltage, to make available an AC input voltage on the output side. The inverter unit also contains a transformer, configured to receive the AC input voltage on the primary side. The transformer is configured, depending on a transformation ratio, in particular a specified transformation ratio, to transform the AC input voltage into the AC heating voltage and to make available the AC heating voltage for heating the filament on the secondary side.

The transformer may receive the AC input voltage that the inverter within the inverter unit makes available on the output side. In particular, the transformer may ensure the galvanic isolation from the filament having a high voltage potential of the tube high voltage applied. In this way the transformer may, similarly due to the transformation ratio on the output side, output a higher, in particular a considerably higher, voltage amplitude than it receives on the input side. Consequently, the transformer may make available the AC heating voltage for heating the filament. In this case, the AC heating voltage may also be referred to as filament voltage.

An advantage of using the transformer is the galvanic isolation of the electric circuits and the possibility of increasing the voltage amplitude. In this embodiment the regulation takes place directly on the basis of current and voltage values present on the filament, hence the AC heating voltage and the AC heating current. This leads to increased accuracy of the regulation, without further conversion of other circuit elements or, for example, an estimation.

According to at least one further embodiment, the inverter unit contains an inverter configured, depending on the DC heating voltage, to make available the AC heating voltage on the output side. The electronic circuit also contains a transformer configured to receive the AC heating voltage on the primary side. The transformer is configured, depending on a transformation ratio, in particular a specified transformation ratio, to transform the AC heating voltage into a filament voltage and make available the filament voltage for heating the filament on the secondary side.

Hence in such embodiments the transformer is not part of the inverter unit. The transformer may receive the AC heating voltage, which the inverter unit makes available on the output side. In particular, the transformer may ensure the galvanic isolation from the filament having a high voltage potential of the tube high voltage applied. In this way the transformer may, similarly due to the transformation ratio on the output side, output a higher, in particular a considerably higher, voltage amplitude than it receives on the input side. Consequently, the transformer may make available the filament voltage for heating the filament. In particular, the filament voltage is an alternating voltage

An advantage of using the transformer is the galvanic isolation of the electric circuits and the possibility of increasing the voltage amplitude. In this embodiment the regulation takes place on the basis of current and voltage values present via the transformer on the filament, hence the AC heating voltage and the AC heating current. All that is necessary for drawing conclusions about the characteristics of the filament is to include the transformation ratio of the transformer.

According to at least one further embodiment of the electronic circuit, the control arrangement is configured to determine a heating impedance from the AC heating voltage and the AC heating current, and to determine the controlled variable depending on the heating impedance, or to determine a heating output from the AC heating voltage and the AC heating current, and to determine the controlled variable depending on the heating output.

In other words, the control arrangement may calculate the heating impedance from the measured values of the AC heating voltage and the AC heating current, in particular as the quotient of these values, the AC heating voltage in this way being the dividend and the AC heating current the divisor. Similarly, the control arrangement may initially determine RMS values from the measured values, hence a RMS AC heating voltage and a RMS AC heating current, and then calculate the quotients of the RMS values. In particular, the heating impedance may also be referred to as heating resistance. The embodiment similarly includes the case in which the controlled variable corresponds to the heating impedance. In particular, the controlled variable may also be directly proportional to the heating impedance.

Alternatively, the control arrangement may for example also calculate the heating output from the measured values of the AC heating voltage and the AC heating current by multiplication. In this case, the controlled variable may be determined depending on the heating output, in particular the controlled variable may also correspond to the heating output, or the controlled variable may be directly proportional to the heating output.

Here and in the following the term impedance may refer both to a complex-valued impedance and to a real-valued impedance, hence an ohmic resistance, unless otherwise stated.

Compared to the steep gradients of the relationship between an AC heating current and the tube current, the relationship between the heating impedance and the tube current has a considerably flatter course. For this reason regulation based on the heating impedance may be more accurate and the target variable reached more quickly. In particular, with the presented embodiment possible overshoots of a regulation process may be reduced or avoided.

According to at least one further embodiment of the electronic circuit, the control arrangement is configured to set the AC heating current, before performance of an initial control loop of the regulating circuit, to a predefined initial value.

In other words, the regulation process of the regulating circuit may start with a value for the AC heating current, which acts as divisor in the heating impedance, having a low positive value as a predefined initial value. In this context, low means small compared to measured values determined during previous measurements. A value of the AC heating current close or equal to zero, would allow the heating impedance to increase to very high values or to a value of infinity.

An advantage of this embodiment is an improved convergence of the regulating circuit on the target value in particular in the initial phase of measurement.

According to at least one further embodiment of the electronic circuit the control arrangement contains a circuit element configured to determine the target value dependent on a tube current of the X-ray tube, a tube high voltage of the X-ray tube and a specified relationship between the tube current and the controlled variable.

In other words, the target value may vary during performance of the regulation, and in particular the target value may be adjusted in an initial implementation of the regulating circuit. The circuit element may in particular be configured to measure the controlled variable or to receive the current measured value of the controlled variable. In this way the target value may in many embodiments also be dependent on the current measured value of the controlled variable.

Similarly, the circuit element may be configured to receive target values for the tube current and the tube high voltage. The circuit element may receive and store the specified relationship between the tube current and the controlled variable, for example by a calibration or other data input. In this way the calibration may also be referred to as filament learning.

The tube current and the tube high voltage may in this way be target variables of a planned X-ray image.

An advantage of this embodiment is the improved accuracy of a temperature adjustment of the filament based on known target values for a respective initial situation before the planned X-ray image.

According to at least one further embodiment of the electronic circuit the AC heating voltage is a non-sinusoidal alternating voltage and the manipulated variable corresponds to the pulse-break ratio of the AC heating voltage.

In particular, the AC heating voltage may contain or be composed of a series of pulses, in particular square-wave pulses. The AC heating voltage may in particular be composed of a series of pulses with a fixed frequency. The manipulated variable may then correspond to the pulse-break ratio of the pulses. In this way a high pulse-break ratio may correspond to a high energy content of the AC heating voltage thus causing a high filament current, and hence leading to a high temperature of the filament. In contrast, a low pulse-break ratio may correspond to a low energy content of the AC heating voltage, hence causing a low value of the filament current leading to a lower temperature of the filament.

This type of AC heating voltage has the advantage of simple implementation in more modern and more cost-effective circuit technology and fast and accurate adjustment of necessary parameters. The inverter may in this way be designed as a PWM inverter. This design is similarly advantageous in relation to the speed of a switching process and the accuracy of the filament current regulation.

According to at least one further embodiment of the electronic circuit the control arrangement contains a PI controller or a PID controller.

The PI controller or the PID controller is in particular configured to vary the manipulated variable depending on the controlled variable.

The PI (proportional-integral) controller contains both a proportional component and an integral component. For the proportional component the relationship between the input and the output variable is defined by a jump function with a defined amplification. The integral component exhibits a linearly rising path between input and output. The PID (proportional-integral-derivative) controller also contains a differential component. A step response is an impulse function with a theoretically infinite magnitude.

An advantage of using PI controllers is the combination of a rapid response capability of the proportional component and a precise correction without residual control deviation of the integral part. Furthermore, the PID controller has the advantage that rapid system deviations may also be corrected by a robust response from the controller. The use of PI or PID controllers simplifies the structure of the electronic circuit according to one or more example embodiments and increases the control accuracy.

According to one or more example embodiments, an X-ray tube system, in particular an X-ray tube system for a computed tomography system, is specified, having an electronic circuit according to one or more example embodiments and the X-ray tube.

The X-ray tube may in this way contain a filament, which may be provided with an AC heating voltage by the electronic circuit. In particular, the electronic circuit is connected to the filament so that the filament voltage may be applied to the filament. Apart from the electronic circuit and the X-ray tube, the X-ray tube system may contain further components such as, for example, a housing and an X-ray anode.

Further embodiments of the X-ray tube system according to one or more example embodiments result directly from the various designs of the electronic circuit according to one or more example embodiments. In particular, individual features and corresponding explanations and advantages relating to the various embodiments of the devices according to the invention may be transferred analogously to corresponding embodiments of the X-ray tube system according to the invention.

According to one or more example embodiments, a medical imaging system having an X-ray tube system according to one or more example embodiments is specified.

The medical imaging system may for example be an X-ray system, in particular a digital X-ray system, both a stationary and a mobile system, or a specialist X-ray machine, such as a computed tomography system (CT system), a cone beam CT system, a mammography system, a dental X-ray system, a fluoroscopy system, an angiography system, a C-arm system or also a conventional X-ray device.

Further embodiments of the medical imaging system according to the invention result directly from the various designs of the X-ray tube system according to the invention or the electronic circuit according to the invention. In particular, individual features and corresponding explanations and advantages relating to the various embodiments of the devices according to the invention may be transferred analogously to corresponding embodiments of the medical imaging system according to the invention.

According to one or more example embodiments, a method for providing an AC heating voltage for heating a filament of an X-ray tube is specified. In this way initially a DC heating voltage dependent on a manipulated variable is converted into an AC heating voltage and the AC heating voltage made available. The AC heating voltage and an AC heating current resulting from the AC heating voltage, in particular on the output side of an inverter unit, are also measured and depending on this a controlled variable is determined. The manipulated variable is varied depending on the controlled variable, in order to regulate the controlled variable to a specified target value.

According to at least one embodiment of the method the filament is heated depending on the AC heating voltage.

According to at least one further embodiment of the method a heating impedance is determined from the AC heating voltage and the AC heating current and the controlled variable is determined depending on the heating impedance or a heating output is determined from the AC heating voltage and the AC heating current and the controlled variable is determined depending on the heating output.

According to at least one further embodiment of the method the AC heating voltage is converted depending on a transformation ratio into a filament voltage and the filament voltage is made available.

According to at least one further embodiment of the method the target value is determined depending on a tube current of the X-ray tube, a tube high voltage of the X-ray tube and a specified relationship between the tube current and the controlled variable.

Further embodiments of the method result directly from the various designs of the electronic circuit and vice versa. In particular, individual features and corresponding explanations and advantages relating to the various embodiments of the electronic circuit according to the invention may be transferred analogously to corresponding embodiments of the method according to the invention. In particular, the electronic circuit according to one or more example embodiments is designed or programmed to carry out a method according to one or more example embodiments. In particular, the electronic circuit according to one or more example embodiments carries out the method according to one or more example embodiments.

Further features and combinations of features of the invention result from at least the figures and the description of these and from the claims. In particular, further embodiments of the invention do not necessarily have to contain all features of one of the claims. Further embodiments of the invention may have features and combinations of features not mentioned in the claims.

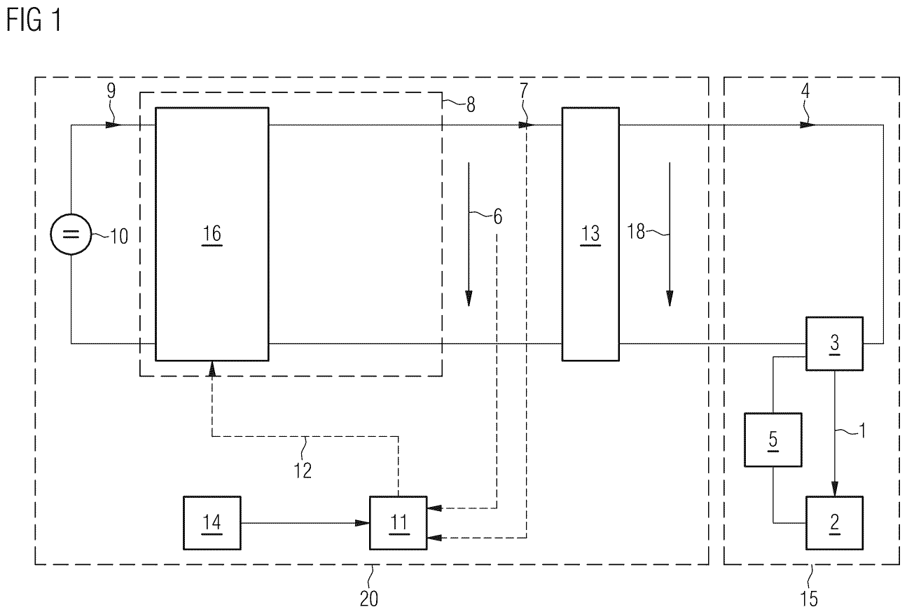

FIG. 1 shows an embodiment of an electronic circuit 20 for providing an AC heating voltage 6 for heating a filament 3 of an X-ray tube 15. The electronic circuit 20 contains an inverter unit 8 configured on the input side to receive a DC heating voltage 10 and to convert the DC heating voltage 10 depending on a manipulated variable 12 into an AC heating voltage 6 and to make available the AC heating voltage 6 on the output side. The electronic circuit 20 also has a control arrangement 11 configured to measure the AC heating voltage 6 and an AC heating current 7 resulting from the AC heating voltage 6 and depending on the AC heating voltage 6 and the AC heating current 7 to determine a controlled variable. The control arrangement 11 is configured to vary the manipulated variable 12 depending on the controlled variable, in order to regulate the controlled variable in a regulating circuit to a specified target value 14.

FIG. 1 shows, similarly schematically, an anode 2 of the X-ray tube 15 and a tube high voltage 5 applied between filament 3 and anode 2 and a tube current 1. These two variables may be critical for an X-ray dose, which may result from an X-ray image and may have an effect on the patient.

The control arrangement 11 may contain in the regulating circuit for example a measuring arrangement, comprising at least one measuring device, an inverter and a controller 21. The controller 21 may in at least one embodiment have a PI or a PID controller. The type of controller 21 may in this way influence the control behavior with regard to an amplitude deviation of the controlled variable and its temporal transient response. In this way, the control arrangement 11 may for example determine from the AC heating voltage 6 and the AC heating current 7 the controlled variable as a quotient of these two variables. Where the AC heating voltage 6 is the dividend and the AC heating current 7 the divisor, the controlled variable may similarly be referred to as heating impedance 17. Similarly, the control arrangement 11 may for example determine the controlled variable as a product of the AC heating voltage 6 and the AC heating current 7. In this case the controlled variable may similarly be referred to as heating output 24.

The specified target value 14 may serve as an input variable of the control arrangement 11 and within the control arrangement 11 be used for comparison with the controlled variable. In this way the inverter may initially invert the controlled variable and then the controller 21 may compare the inverted value of the controlled variable with the target value 14, in particular by calculating a difference.

The manipulated variable 12 may be made available by the control arrangement 11 to the inverter 16 within the inverter unit 8. In at least one embodiment the manipulated variable 12 may correspond to a pulse-break ratio of the AC heating voltage 6. With the pulse-break ratio the average AC heating voltage 6 may be adjusted and as a result of this the average AC heating current 7. These two variables may impact the temperature of the filament 3.

FIG. 1 also shows a transformer 13, which in many exemplary embodiments may galvanically isolate the AC heating voltage 6 from an electric circuit of the filament 3. The transformer 13 receives the AC heating voltage 6 on the input side and from this may generate a filament voltage 18. Depending on a transformation ratio, the transformer 13 may for example transform the AC heating voltage 6 into a high voltage. The filament voltage 18 may for example be an alternating voltage. The filament voltage 18 may lead to a filament current 4, that flows through the filament 3 and may have a direct impact on a temperature change of the filament 3.

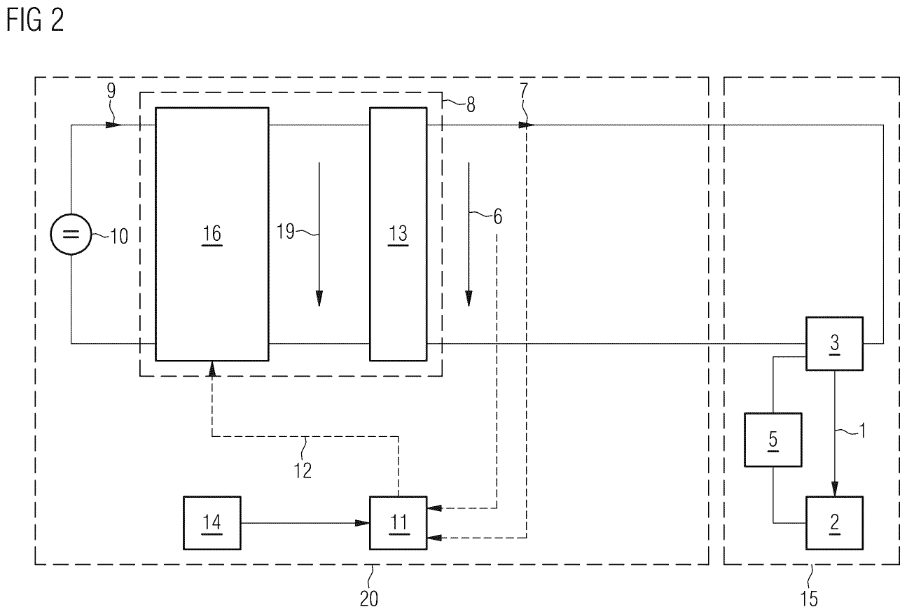

A further embodiment of the electronic circuit 20 is shown in the block diagram in FIG. 2. The exemplary embodiment shown in FIG. 2 may analogously have all the features from FIG. 1, unless otherwise shown or mentioned. In FIG. 2 the inverter unit 8 may contain a transformer 13. In this way the transformer 13 may receive an AC input voltage 19, that may be generated from the inverter 16. On the output side the inverter unit 8 may provide the AC heating voltage 6, which may result in an AC heating current 7. The AC heating current 7 may flow directly through the filament 3 and have a direct impact on a temperature change of the filament 3. In this case the AC heating voltage 6 may also be referred to as filament voltage 18, since it may be applied directly at the filament 3.

The control arrangement 11 receives the AC heating voltage 6, the AC heating current 7 and the target value 14 on the input side and from this may determine a controlled variable. The control arrangement 11 may generate a manipulated variable 12, which may be made available to the inverter 16 within the inverter unit 8.

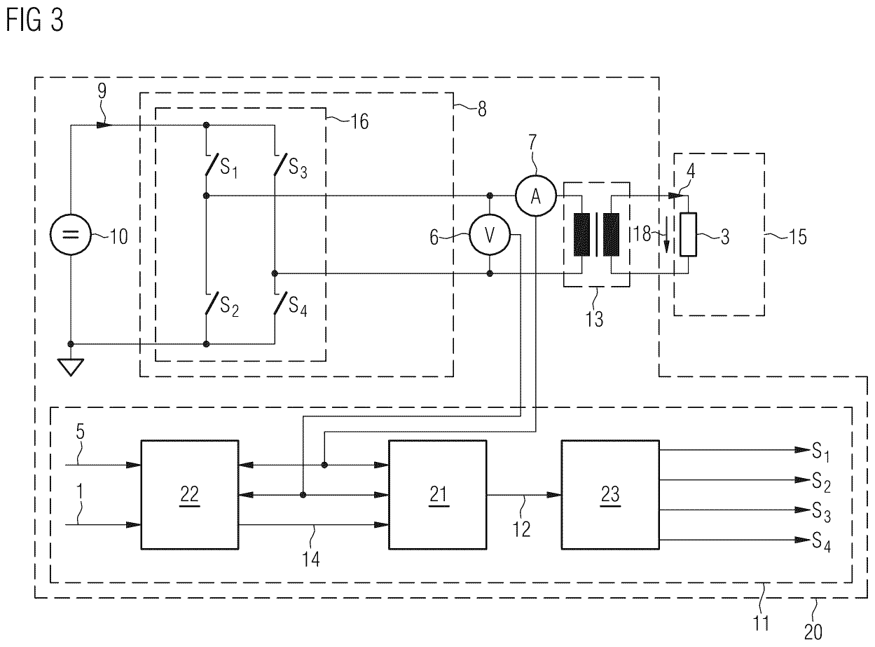

FIG. 3 shows a further schematic representation of the electronic circuit 20 according to one or more example embodiments. Here the same features represented in figures FIG. 1 and FIG. 2 apply, unless otherwise stated.

In the embodiment represented as exemplary, apart from the controller 21 and the inverter, the control arrangement 11 also contains a control signal generation 23 and a circuit element 22. On the input side the controller 21 receives the AC heating voltage 6, the AC heating current 7 and the target value 14. On the output side the controller makes the manipulated variable 12 available to the control signal generation 23. The control signal generation 23 may for example generate individual switch positions as an input signal to the inverter 16 depending on the manipulated variable 12 applied on the input side and make this available to the inverter 16. The designations S1, S2, S3 and S4 characterize in particular an exemplary embodiment, in which the inverter 16 has a full-bridge and contains four switches. The four switches may for example be controlled by output signals from the control signal generation 23. The circuit element 22 receives specified values of the tube high voltage 5 and the tube current 1. Similarly, the circuit element 22 may for example receive the measured values of the current AC heating voltage 6 and the current AC heating current 7. From these values, the circuit element 22 may determine the target value 14, in particular based on a specified relationship between the tube current 1 and the controlled variable, which for example has been determined during filament learning. The circuit element 22 may make the target value 14 available to the controller 21.

FIG. 3 shows a circuit element between the inverter 16 and filament 3, for example as a reactive network. In another embodiment, the circuit element between the inverter 16 and the filament 3 may be also designed as a resonant network. This may be indicated schematically by a series capacitor in a supply line to the transformer 13.

In FIG. 3 the transformer 13 is also represented which on the input side receives the AC heating voltage 6 and depending on the transformation ratio may make the filament voltage 18 available. The filament voltage 18 is applied to the filament 3 and may lead to a filament current 4, that flows through the filament 3. On the input side the inverter unit 8 may be operated by a DC heating voltage 10 and a resulting DC heating current 9.

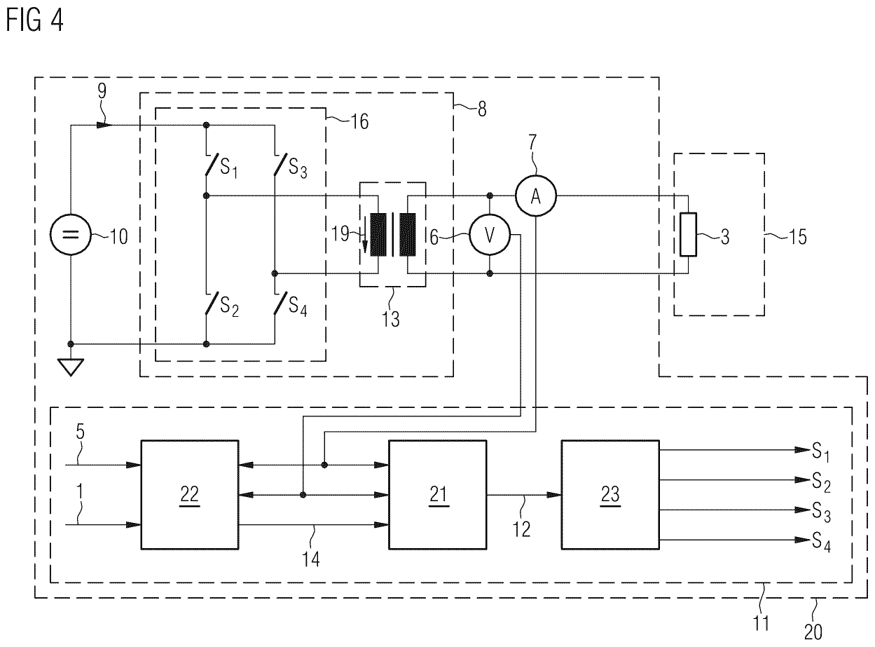

FIG. 4 shows a further embodiment of the electronic circuit 20. The controller 21, the control signal generation 23 and the circuit element 22 are presented here within the control arrangement 11. Here, on the input side, the controller 21 receives the AC heating voltage 6, the AC heating current 7 and the target value 14. From this the controller 21 may generate the manipulated variable 12 and make it available to the control signal generation 23. The control signal generation 23 may for example generate individual switch positions as an input signal to the inverter 16 depending on the manipulated variable 12 applied on the input side and make this available to the inverter 16. The designations S1, S2, S3 and S4 characterize in particular an exemplary embodiment, in which the inverter 16 has a full-bridge and contains four switches. The four switches may for example be controlled by output signals from the control signal generation 23.

The circuit element 22 receives specified values of the tube high voltage 5 and the tube current 1. Similarly, the circuit element 22 may for example receive the measured values of the current AC heating voltage 6 and the current AC heating current 7. From these values the circuit element 22 may determine the target value 14, in particular based on the specified relationship between the tube current 1 and the controlled variable, which for example has been determined during filament learning. The circuit element 22 may make the target value 14 available to the controller 21.

FIG. 4 also presents the transformer 13 within the inverter unit 8, which receives the AC input voltage 19 on the input side and depending on the transformation ratio may make the AC heating voltage 6 available. The AC heating voltage 6 is applied to the filament 3 and may lead to an AC heating current 7 that flows through the filament 3. On the input side the inverter unit 8 may be operated by a DC heating voltage 10 and a resulting DC heating current 9.

FIG. 4 shows an embodiment in which the AC heating voltage 6 and the AC heating current 7 are measured directly on the filament 3. In this case, the heating impedance 17 may for example be determined without consideration of the manipulated variable 12, in particular the control factor of the inverter 16. The algorithm described in the following may be applied for regulation of the temperature of the filament 3.

Regulation based on the heating impedance 17 has the advantage in particular that the targeted temperature of the filament 3 may be reached particularly early. Ohm's law states

$${R}_{f} = \frac{{U}_{f}}{{I}_{f}} = ρ \frac{l}{s} = {ρ}_{0} ( 1 + a T ) \frac{l}{s} ,$$

where R_{f} denotes the Ohmic resistance of the filament 3, U_{f} the voltage applied to the filament 3 and I_{f} the current flowing through the filament 3, ρ the specific resistance of the filament 3, l the length of the filament 3, s its cross-sectional area, ρ₀ the specific resistance of the filament 3 at 0° C., α the temperature coefficients of the specific resistance, and T the temperature of the filament 3 at 0° C. For tungsten we have for example

$$a = 0 , 0046 \frac{1}{°C}$$

and ρ₀=5.5*10⁻⁸ Ωm.

From this the following equation for calculating the temperature may be derived:

$$T = \frac{( \frac{{R}_{f} \frac{s}{l}}{{ρ}_{0}} - 1 )}{a} = \frac{{R}_{f} s}{a {ρ}_{0} l} - \frac{1}{a} = k {R}_{f} - b = k \frac{{U}_{f}}{{I}_{f}} - b ,$$

where

$$k = \frac{s}{a {ρ}_{0} l}$$

and b=1/α.

It follows that the temperature of the filament 3 is linearly dependent on its resistance. This linearity means that the control with the internal regulating circuit has the result that the temperature may be brought to the desired value more stably, more precisely and more quickly.

The measurement of the two values U_{f} and I_{f} may be viewed as equivalent to the measurement of the temperature of the filament 3. Since the direct measurement of these two values is technically difficult and expensive, it is advantageous to use other variables that are easier to measure and have a direct relationship with R_{f}, as is the case for FIG. 4 through the described measurement of the DC heating voltage 10 and the DC heating current 9.

The following algorithm may for example be used:

1. Setting a new expected filament resistance R_{ref}, that has been learned by filament learning.
2. Setting a low current I_{d} through the filament 3, so that the feedback current is not exactly zero.
3. Measuring the DC heating voltage 10 and the DC heating current 9.
4. Calculating the actual filament resistance R_{d}.
5. Calculating the difference ΔR between an expected filament resistance R_{ref} and the actual filament resistance R_{d}.
6. Using the controller 21 to calculate the manipulated variable 12 and from this the control signals for the inverter 16 from ΔR.
7. Repeating steps 3 to 7.

A resistance-based filament-learning may for example be implemented according to the following algorithm:

1. Set I_{f} to I_{f,Ux} and KV_{s,ls} to 0 (false).

### 2. Set C=0 and KV=KVₛ[0].

3. If KV_{s,ls}[C]=1 (true), go to step 12.
4. Apply I_{f} to the filament 3 and wait until it stabilizes.
5. Apply the current tube high voltage 5 and exposure time to the X-ray tube 15.
6. Take an X-ray image and measure the tube current 1 I_{T} and the filament voltage U_{f} as soon as these are stable.
7. Calculate the resistance

$$R = \frac{{U}_{f}}{{I}_{f}} .$$

8. Save the tuple (KV, I_{f}, I_{T}, U_{f}, R).
9. If I_{f}>I_{f,ulx}, set KV_{s,ls} to 1 (true).
10. If I_{T}>min (I_{T,ulg}, I_{T,ulx}), set KV_{s,ls} to 1 (true).

### 11. If

$${I}_{T} > min ( \frac{{P}_{ulx}}{K V} , \frac{{P}_{ulg}}{K V} ) ,$$

set KV_{s,ls} to 1 (true).

### 12. Set C→C+1.

13. If C<C_{KV}, set KVₛ(C_{KV}) and go to step 3.

14. If all elements of KV_{s,ls} are set to 1 (true), go to step 16.

15. Set I_{f}≥I_{f}+I_{f,s}. C=0, KV=KVₛ[0] and go to step 3.

### 16. End.

Here, C_{KV} denotes the number of X-ray voltages considered, I_{f,ulx} an upper limit for the current through the filament 3, I_{f,ulx} a lower limit for the current through the filament 3, I_{T,ulx} an upper limit for the tube current 1, I_{T,ulg} a maximum tube current 1 that may be provided, Pᵤₗₓ an upper limit for the tube power, P_{ulg} a maximum tube power that may be provided, I_{f,s} a specified current value step, KVₛ an array of the variable C_{KV}, that stores all X-ray voltages considered, and KV_{s,ls} an array of the variable C_{KV}, that stores information on whether the learning for the individual X-ray voltages is complete.

An advantage is that the controller 21 does not need to know the filament voltage 18 and the filament current 4. The filament current 4 may also be held more stable, since it is controlled by its resistance in line with its temperature. This is for example very helpful for time-critical X-ray images requiring a high space-time resolution.

In addition, with such control, at the start of the X-ray imaging the filament 3 is neither too hot nor too cold, which would result in a dose rate that is too high or too low. With time-controlled exposure, an image that is too light or too dark may be avoided. The generator and the X-ray tube may also be protected from overload.

The resistance as an indicator of the filament temperature is also advantageous in predictive maintenance, since deviations in the filament temperatures in relation to data from the scan history enable simple detection of filament aging.

With the described example embodiments, the filament learning process may be carried out over longer intervals of time. This is in particular due to the fact that by using the heating output 24 as a controlled variable the aging of the filament 3 and thus the change in its heating impedance 17 may be actively mitigated, whereby ideally the number of free electrons remains the same. As the filament 3 does not age uniformly, however, its emission characteristics will still change with progressive aging. But this happens at considerably longer intervals than with the conventional method.

Independent of the grammatical term usage, individuals with male, female or other gender identities are included within the term.

It will be understood that, although the terms first, second, etc. may be used herein to describe various elements, components, regions, layers, and/or sections, these elements, components, regions, layers, and/or sections, should not be limited by these terms. These terms are only used to distinguish one element from another. For example, a first element could be termed a second element, and, similarly, a second element could be termed a first element, without departing from the scope of example embodiments. As used herein, the term “and/or,” includes any and all combinations of one or more of the associated listed items. The phrase “at least one of” has the same meaning as “and/or”.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative used herein interpreted descriptors accordingly. In addition, when an element is referred to as being “between” two elements, the element may be the only element between the two elements, or one or more other intervening elements may be present.

Spatial and functional relationships between elements (for example, between modules) are described using various terms, including “on,” “connected,” “engaged,” “interfaced,” and “coupled.” Unless explicitly described as being “direct,” when a relationship between first and second elements is described in the disclosure, that relationship encompasses a direct relationship where no other intervening elements are present between the first and second elements, and also an indirect relationship where one or more intervening elements are present (either spatially or functionally) between the first and second elements. In contrast, when an element is referred to as being “directly” on, connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Also, the term “example” is intended to refer to an example or illustration.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

It is noted that some example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed above. Although discussed in a particular manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Specific structural and functional details disclosed herein are merely representative for purposes of describing example embodiments. The present invention may, however, be embodied in many alternate forms and should not be construed as limited to only the embodiments set forth herein.

In addition, or alternative, to that discussed above, units and/or devices according to one or more example embodiments may be implemented using hardware, software, and/or a combination thereof. For example, hardware devices may be implemented using processing circuitry such as, but not limited to, a processor, Central Processing Unit (CPU), a Graphics Processing Unit (GPU), a controller, an arithmetic logic unit (ALU), a digital signal processor, a microcomputer, a field programmable gate array (FPGA), a System-on-Chip (SoC), a programmable logic unit, a microprocessor, or any other device capable of responding to and executing instructions in a defined manner. Portions of the example embodiments and corresponding detailed description may be presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., a processor, Central Processing Unit (CPU), a controller, an arithmetic logic unit (ALU), a digital signal processor, a microcomputer, a microprocessor, etc.), the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto, thereby transforming the processor into a special purpose processor.

Software and/or data may be embodied permanently or temporarily in any type of machine, component, physical or virtual equipment, or computer storage medium or device, capable of providing instructions or data to, or being interpreted by, a hardware device. The software also may be distributed over network coupled computer systems so that the software is stored and executed in a distributed fashion. In particular, for example, software and data may be stored by one or more computer readable recording mediums, including the tangible or non-transitory computer-readable storage media discussed herein.

Even further, any of the disclosed methods may be embodied in the form of a program or software. The program or software may be stored on a non-transitory computer readable medium and is adapted to perform any one of the aforementioned methods when run on a computer device (a device including a processor). Thus, the non-transitory, tangible computer readable medium, is adapted to store information and is adapted to interact with a data processing facility or computer device to execute the program of any of the above mentioned embodiments and/or to perform the method of any of the above mentioned embodiments.

Example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particular manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

According to one or more example embodiments, computer processing devices may be described as including various functional units that perform various operations and/or functions to increase the clarity of the description. However, computer processing devices are not intended to be limited to these functional units. For example, in one or more example embodiments, the various operations and/or functions of the functional units may be performed by other ones of the functional units. Further, the computer processing devices may perform the operations and/or functions of the various functional units without sub-dividing the operations and/or functions of the computer processing units into these various functional units.

Units and/or devices according to one or more example embodiments may also include one or more storage devices. The one or more storage devices may be tangible or non-transitory computer-readable storage media, such as random access memory (RAM), read only memory (ROM), a permanent mass storage device (such as a disk drive), solid state (e.g., NAND flash) device, and/or any other like data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable storage medium into the one or more storage devices and/or one or more computer processing devices using a drive mechanism. Such separate computer readable storage medium may include a Universal Serial Bus (USB) flash drive, a memory stick, a Blu-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a local computer readable storage medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other like medium.

The one or more hardware devices, the one or more storage devices, and/or the computer programs, program code, instructions, or some combination thereof, may be specially designed and constructed for the purposes of the example embodiments, or they may be known devices that are altered and/or modified for the purposes of example embodiments.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as a computer processing device or processor; however, one skilled in the art will appreciate that a hardware device may include multiple processing elements or processors and multiple types of processing elements or processors. For example, a hardware device may include multiple processors or a processor and a controller. In addition, other processing configurations are possible, such as parallel processors.

The computer programs include processor-executable instructions that are stored on at least one non-transitory computer-readable medium (memory). The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc. As such, the one or more processors may be configured to execute the processor executable instructions.

The computer programs may include: (i) descriptive text to be parsed, such as HTML (hypertext markup language) or XML (extensible language), markup (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

Further, at least one example embodiment relates to the non-transitory computer-readable storage medium including electronically readable control information (processor executable instructions) stored thereon, configured in such that when the storage medium is used in a controller of a device, at least one embodiment of the method may be carried out.

The computer readable medium or storage medium may be a built-in medium installed inside a computer device main body or a removable medium arranged so that it can be separated from the computer device main body. The term computer-readable medium, as used herein, does not encompass transitory electrical or electromagnetic signals propagating through a medium (such as on a carrier wave); the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices); volatile memory devices (including, for example static random access memory devices or a dynamic random access memory devices); magnetic storage media (including, for example an analog or digital magnetic tape or a hard disk drive); and optical storage media (including, for example a CD, a DVD, or a Blu-ray Disc). Examples of the media with a built-in rewriteable non-volatile memory, include but are not limited to memory cards; and media with a built-in ROM, including but not limited to ROM cassettes; etc. Furthermore, various information regarding stored images, for example, property information, may be stored in any other form, or it may be provided in other ways.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices); volatile memory devices (including, for example static random access memory devices or a dynamic random access memory devices); magnetic storage media (including, for example an analog or digital magnetic tape or a hard disk drive); and optical storage media (including, for example a CD, a DVD, or a Blu-ray Disc). Examples of the media with a built-in rewriteable non-volatile memory, include but are not limited to memory cards; and media with a built-in ROM, including but not limited to ROM cassettes; etc. Furthermore, various information regarding stored images, for example, property information, may be stored in any other form, or it may be provided in other ways.

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

Although described with reference to specific examples and drawings, modifications, additions and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

1. An electronic circuit configured to provide an AC heating voltage for heating a filament of an X-ray tube, the electronic circuit comprising:
an inverter configured on an input side to receive a DC heating voltage and to convert the DC heating voltage into an AC heating voltage based on a manipulated variable and to provide the AC heating voltage on an output side; and
a controller configured to,
measure the AC heating voltage and an AC heating current resulting from the AC heating voltage,
determine a controlled variable based on the AC heating voltage and the AC heating current, and
vary the manipulated variable based on the controlled variable to regulate the controlled variable in a regulating circuit to a specified target value.

2. The electronic circuit of claim 1, wherein
the inverter is configured to provide an AC input voltage on the output side based on the DC heating voltage, and the inverter includes,
a transformer configured to receive the AC input voltage on a primary side, to transform the AC input voltage into the AC heating voltage, and to provide the AC heating voltage for heating the filament on a secondary side.

3. The electronic circuit of claim 1, wherein the inverter is configured to provide the AC heating voltage on the output side based on the DC heating voltage, and the electronic circuit includes,
a transformer configured to receive the AC heating voltage on a primary side, to transform the AC heating voltage into a filament voltage based on a transformation ratio, and to provide the filament voltage for heating the filament on a secondary side.

4. The electronic circuit of claim 1, wherein the controller is configured to,
determine a heating impedance based on the AC heating voltage and the AC heating current and to determine the controlled variable based on the heating impedance; or
determine a heating output based on the AC heating voltage and the AC heating current and to determine the controlled variable based on the heating output.

5. The electronic circuit of claim 1, wherein the controller is configured to set the AC heating current to a predefined initial value before performance of an initial control loop of the regulating circuit.

6. The electronic circuit of claim 1, wherein the controller includes a circuit configured to determine the target value based on a tube current of the X-ray tube, a tube high voltage of the X-ray tube and a specified relationship between the tube current and the controlled variable.

7. The electronic circuit of claim 1, wherein the AC heating voltage is a non-sinusoidal alternating voltage and the manipulated variable corresponds to a pulse-break ratio of the AC heating voltage.

8. The electronic circuit of claim 1, wherein the controller includes a proportional-integral (PI) controller or a proportional-integral-derivative (PID) controller.

9. An X-ray tube system comprising:
the electronic circuit of claim 1; and
the X-ray tube.

10. A medical imaging system comprising:
the X-ray tube system of claim 9.

11. A method for providing an AC heating voltage for heating a filament of an X-ray tube, the method comprising:
converting a DC heating voltage based on a manipulated variable into an AC heating voltage and providing the AC heating voltage; and
measuring the AC heating voltage and an AC heating current resulting from the AC heating voltage;
determining a controlled variable based on the measuring; and
varying the manipulated variable based on the controlled variable to regulate the controlled variable to a specified target value.

12. A method for heating a filament of an X-ray tube, the method comprising:
performing the method of claim 11; and
heating the filament based on the AC heating voltage.

13. The method of claim 11, further comprising:
determining a heating impedance based on the AC heating voltage and the AC heating current and determining the controlled variable based on the heating impedance; or
determining a heating output from the AC heating voltage and the AC heating current and determining the controlled variable based on the heating output.

14. The method of claim 11, further comprising:
converting the AC heating voltage into the filament voltage based on a transformation ratio and providing the filament voltage.

15. The method of claim 11, wherein the target value is determined based on a tube current of the X-ray tube, a tube high voltage of the X-ray tube and a specified relationship between the tube current and the controlled variable.

16. The electronic circuit of claim 3, wherein the controller is configured to,
determine a heating impedance based on the AC heating voltage and the AC heating current and to determine the controlled variable based on the heating impedance; or
determine a heating output based on the AC heating voltage and the AC heating current and to determine the controlled variable based on the heating output.

17. The electronic circuit of claim 16, wherein the controller is configured to set the AC heating current to a predefined initial value before performance of an initial control loop of the regulating circuit.

18. The electronic circuit of claim 17, wherein the controller includes a circuit configured to determine the target value based on a tube current of the X-ray tube, a tube high voltage of the X-ray tube and a specified relationship between the tube current and the controlled variable.

19. The electronic circuit of claim 18, wherein the AC heating voltage is a non-sinusoidal alternating voltage and the manipulated variable corresponds to a pulse-break ratio of the AC heating voltage.

20. The electronic circuit of claim 19, wherein the controller includes a proportional-integral (PI) controller or a proportional-integral-derivative (PID) controller.
